(19) United States
(12) Patent Application Publication
(10) Pub. No.: US 2005/0166249 A1
(43) Pub. Date: Jul. 28, 2005

(54) Fitting video feed to a display device

(76) Inventor: Wiatt Kettle, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/765,595

(22) Filed: Jan. 26, 2004

(51) Int. Cl. H04N 7/173; H04N 7/01; H04N 9/74; H04N 11/20; H04N 7/16

(52) U.S. Cl. 725/116; 725/115; 725/146; 725/145; 348/580; 348/441; 348/445

(57) ABSTRACT

A frame of a video feed is fitted to a display device. At least one marker is ascertained that defines a region of the frame of the video feed. The region has a horizontal to vertical ratio that matches a horizontal resolution to vertical resolution ratio of the display device. At least one row of the region defined by the at least one marker is buffered. The region of the frame defined by the at least one marker is displayed on the display device.

### FIELD OF THE INVENTION

This invention relates in general to video technology and, more particularly, to fitting a frame of a video feed to a display device.

### BACKGROUND OF THE INVENTION

Currently, video is displayed principally in one of two aspect ratio formats, 16:9 (1.78) or 4:3 (1.33). Although, other aspect ratio formats are possible. Conventional television (TV) and digital (DTV) are often displayed at the 1.33 aspect ratio. High definition television (HDTV) is often displayed at the 16:9 (1.78) aspect ratio.

The current solution for broadcasting content to fit both 1.78 and 1.33 aspect ratios requires the use of two separate broadcasts. One broadband channel broadcast transmits the 1.78 aspect ratio and one lower bandwidth channel broadcast transmits the 1.33 aspect ratio. As a result, additional bandwidth is necessary to broadcast the same video content in the two different video formats.

Additionally, digital video content is often stored in each of the formats separately on one or multiple media elements. Storing the media in both formats takes significantly more storage space than storing it in only one format.

### SUMMARY OF THE INVENTION

According to principles of the present invention, in one embodiment, a frame of a video feed is fitted to a display device. At least one marker is ascertained that defines a region of the frame of the video feed. The region has a horizontal to vertical ratio that matches a horizontal resolution to vertical resolution ratio of the display device. At least one row of the region defined by the at least one marker is buffered. The region of the frame defined by the at least one marker is displayed on the display device.

### DESCRIPTION OF THE DRAWINGS

FIG. 1 is a block diagram illustrating one embodiment of the present invention display device.

FIG. 2 is a diagram illustrating one embodiment of a frame of the video feed of FIG. 1 and the region of the frame.

FIG. 3 is a diagram illustrating another embodiment of a frame of the video feed of FIG. 1 and the region of the frame.

FIG. 4 is a diagram illustrating an alternate embodiment of a frame of the video feed of FIG. 1 and the regions of the frame.

FIG. 5 is a flow chart illustrating one embodiment of the present invention method for transmitting a video feed to a display device.

### DETAILED DESCRIPTION OF THE INVENTION

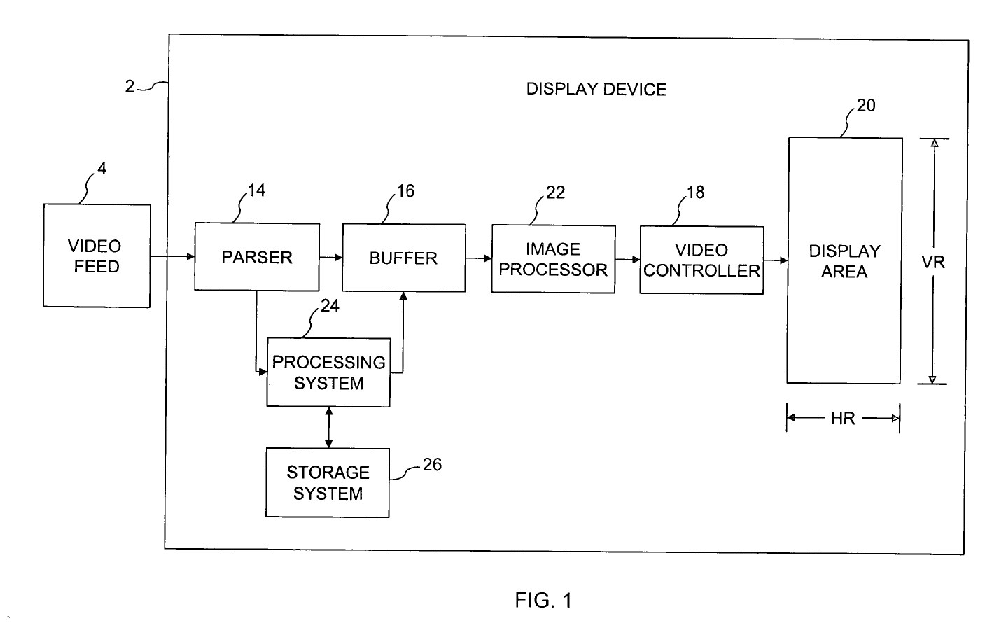

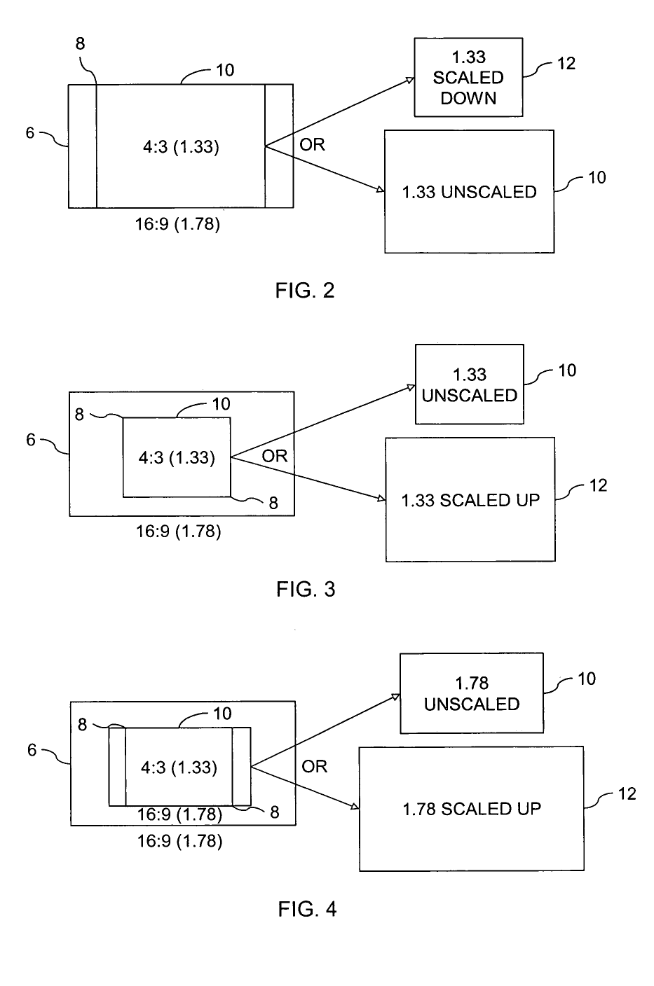

FIG. 1 shows one embodiment of display device 2 for receiving video feed 4. FIGS. 2-4 illustrate example embodiments of frames 6 of video feed 4. In one embodiment, frame 6 has a horizontal to vertical ratio of 16:9. Although other ratios are possible, 16:9 is the most likely resolution in which high definition television (HDTV) will be transmitted.

In one embodiment, video feed 4 includes one or more markers 8 defining region 10 of each frame 6 of video feed 4. Although markers 8 are shown on particular corners of region 10, alternatively, markers are on any location suitable for indicating region 10. In one embodiment, markers 8 are at least one horizontal or vertical coordinate and may also be a pair of horizontal and vertical coordinates.

In an alternate embodiment, video feed 4 is free from markers 8. Markers 8 are selected by display device 2 and imputed to frames 6.

Region 10 has a horizontal to vertical ratio matching a horizontal resolution to vertical resolution ratio of display device 2. In one embodiment, Region 10 has a horizontal to vertical ratio of 4:3. Although other ratios are possible, 4:3 is the standard aspect ratio of conventional television (TV) and most digital (DTV) content.

In one embodiment, region 10 is displayed on display device 2 without scaling. In an alternate embodiment, region 10 is scaled to achieve a scaled region 12. Scaled region 12 is displayed on display device 2.

In one embodiment, a single horizontal marker location 8 is added to the beginning of each frame 6 within a 1.78 format transmission. FIG. 2 shows a graphical representation of marker 8 within frame 6. If display device 2 is a 1.78 aspect ratio device, the marker may be ignored and frame 6 decoded and displayed in its entirety.

If, on the other hand, display device 2 has a 1.33 aspect ratio, display device 2 will buffer and scale the image region 10 defined by the single marker 8. Horizontal marker 8 defines a 1.33 region 10 of the 1.78 source to be cropped. Buffering of a row within the crop region 10 starts at the marker 8 and terminates at the column defined by: (vertical resolution of display device)*4/3 +marker. After a sufficient number of rows for a frame or field have arrived, they may be displayed without scaling or further manipulation if the vertical resolution of the display device matches that of the incoming data stream. This is illustrated by the 1.33 unscaled region 10.

Otherwise the row or frame buffer data (1.33 aspect) is then routed through an image processor to scale the frame to match the display device requirements. This is illustrated by the 1.33 scaled down region 12.

In this embodiment, marker 8 has a valid numerical range of 0 to 480 for the maximum HDTV resolution of 1080×1920 (vertical×horizontal). Valid ranges for lower resolutions scale accordingly.

In a second embodiment, two markers 8 are added to the beginning of each frame 6. The pair of markers 8 provides more flexibility when cropping images and can be extended in several ways. A 4:3 cropped portion of a 1.78 video signal does not have to have a vertical resolution matching the 1.78 signal. FIG. 3 shows a graphical representation of markers 8 within frame 6. Any 4:3 portion could be cropped and scaled to match the resolution of a 4:3 display device 2. This includes zooming in or out on any region of the screen. The marker coordinates locate a default crop region 10 but display device 2 may also accept offsets and zoom parameters, if it is so desired. For example, a user would be able to use the coordinates for a 4:3 zoom setting, full 4:3 setting, or set the 4:3 display to ignore the coordinates and display the video source in a letterbox format. Similar to the first embodiment, regions 10 and 12 represent unscaled and scaled regions.

If a 1.78 display device 2 receiving a 1.78 input signal is set to a zoom mode, the centroid defined by a marker pair could be used to specify a zoom location within the video which would display most of the intended action. FIG. 4 illustrates this embodiment. This embodiment allows for an alternate viewer experience, which may or may not be a 1.78 aspect ratio on a 1.78 display device.

Referring again to FIG. 1, in one embodiment, display device 2 includes parser 14, buffer 16, video controller 18, display area 20, and optionally, image processor 22, processing system 24, and storage system 26.

Parser 14 is any combination of hardware and executable code configured to parse at least one marker 8 from video feed 4. In one embodiment, markers 8 are embedded within a frame header of video feed 4.

Buffer 16 is any apparatus or system configured to selectively store rows of region 10 defined by the at least one marker 8.

Video controller 18 is any combination of hardware and executable code configured to display, in display area 20, buffered rows.

Display area 20 is a portion of display device 2 whereon images are displayed. Display area 20 has a horizontal resolution to vertical resolution ratio relating the horizontal resolution HR to the vertical resolution VR of display area 20.

Image processor 22 is any combination of hardware and executable code configured to scale region 10 to achieve scaled region 12. Scaled region 12 fits the horizontal resolution HR and vertical resolution VR of display area 20.

Processing system 24 is any combination of hardware and executable code configured to calculate from a single marker and a horizontal resolution HR to vertical resolution VR ratio, a second marker defining region 10. Although pictured and discussed as separate from processing system 24, parser 14, video controller 18, and image processor 22 are alternatively integral with or have portions integral with processing system 24.

Storage system 26 is any device or system configured to store data or executable code. Storage system 26 may also be a program storage system tangibly embodying a program, applet, or instructions executable by processing system 24 for performing the method steps of the present invention executable by processing system 24. Storage system 26 may be any type of storage media such as magnetic, optical, or electronic storage media.

Storage system 26 is illustrated in FIG. 1 as a single device. Alternatively, storage system 26 may include more than one device. Furthermore, each device of storage system 26 may be embodied in a different media type. For example, one device of storage system 26 may be a magnetic storage media while another device of storage system 26 is an electronic storage media.

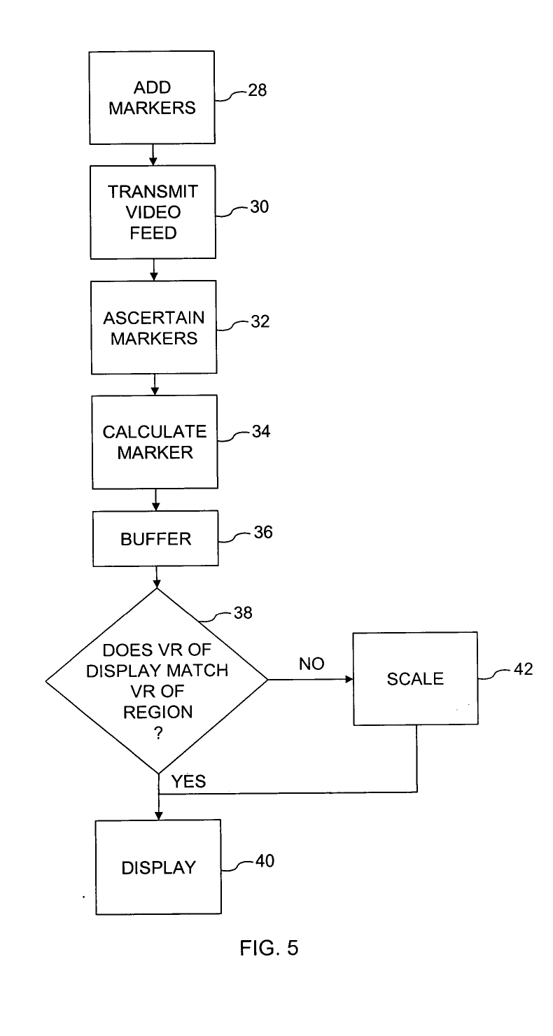

FIG. 5 is a flow chart representing steps of one embodiment of the present invention. Although the steps represented in FIG. 5 are presented in a specific order, the present invention encompasses variations in the order of steps. Furthermore, additional steps may be executed between the steps illustrated in FIG. 5 without departing from the scope of the present invention.

In one embodiment, at least one marker 8 is added 28 to video feed 4. Markers 8 may be added by any method. In one examples marker locations are manually selected and markers 8 are inserted with coordinates at the desired locations. This example may be very similar to that already employed in the Telecine process used to convert film to “video”. To locate marker location(s) for film to video editing, the technician operating Telecine process would first select the desired 1.78 region from the larger film format corresponding to current methods that include anamorphic scaling to a 0.78 aspect ratio. Then the step which is currently taken to further crop the image to 1.33 aspect ratio could be a virtual step which digitally marks where the cut(s) should be.

Markers 8 define region 10 of frame 6. Region 10 has a horizontal to vertical ratio matching a horizontal resolution to vertical resolution ratio of display device 2.

Video feed 4 is transmitted 30 to display device 2. At least one marker 8 is ascertained 32, defining region 10 of frame 6. Region 10 has a horizontal to vertical ratio matching a horizontal resolution HR to vertical resolution VR ratio of display area 20 of display device 2. In one embodiment, the markers 8 are ascertained 32 by parsing them from video feed 4. The markers are parsed out from a header of video feed 4.

In an alternate embodiment, markers 8 are ascertained by fixing marker 8 for each video feed 4.

In one embodiment, a pair of markers 8 defining the boundaries of region 10 is ascertained 32. In an alternate embodiment, a single marker 8 defining a first corner of region 10 is ascertained 32. A second corner is calculated 34 from the single marker and the horizontal resolution HR to vertical resolution VR ratio of display area 20 of display device 2.

At least one row of region 10, defined by the markers 8, is buffered 36. In one embodiment, buffering 36 of a row within the region 10 starts at marker 8 and terminates at the column defined by the formula: (vertical resolution VR of display device)*4/3+marker 8.

If the vertical resolution of display device 2 matches 38 that of the incoming data stream, frame 6, after a sufficient number rows for frame 6 have arrived they may be displayed 40 without further manipulation. Otherwise, the buffer data is routed through image processor 22 to scale 42 region 10 to scaled region 12, which matches the horizontal resolution HR to vertical resolution VR ratio of display device 2. Scaled region 12 is then displayed 40.

Under the single marker format, the marker has a valid numerical range of 0 to 480 for the maximum HDTV resolution of 1080×1920 (vertical×horizontal). Valid ranges for lower resolutions scale accordingly. For multiple marker formats markers consist of row, column pairs which can describe any pixel within the video feed 4 resolution.

The foregoing description is only illustrative of the invention. Various alternatives and modifications can be devised by those skilled in the art without departing from the invention. Accordingly, the present invention embraces all such alternatives, modifications, and variances that fall within the scope of the appended claims.

1. A method for fitting a frame of a video feed to a display device, the method comprising:
ascertaining at least one marker defining a region of the frame, the region having a horizontal to vertical ratio matching a horizontal resolution to vertical resolution ratio of the display device;
buffering at least one row of the region defined by the at least one marker; and
displaying, on the display device, the region of the frame defined by the at least one marker.

2. The method of claim 1 wherein ascertaining at least one marker includes parsing out the at least one marker from the video feed.

3. The method of claim 2 wherein parsing out the at least one marker from the video feed includes parsing out the at least one marker from a header of the video feed.

4. The method of claim 1 wherein ascertaining at least one marker includes fixing the at least one marker for each video feed.

5. The method of claim 1 wherein ascertaining at least one marker includes ascertaining a single marker defining a first corner of the region and calculating from the single marker and the horizontal resolution to vertical resolution ratio a second corner opposite the first corner of the region.

6. The method of claim 1 wherein ascertaining at least one marker includes ascertaining two markers defining opposite corners of the region.

7. The method of claim 1 further including, scaling the region to fit the horizontal and vertical resolution of the display.

8. The method of claim 1 wherein buffering at least one row of the region includes buffering each row of the region.

9. A method for transmitting a video feed to a display device, the method comprising:
adding, to the video feed, at least one marker defining a region of the frame, the region having a horizontal to vertical ratio matching a horizontal resolution to vertical resolution ratio of the display device;
transmitting the video feed to the display device;
parsing the at least one marker from the video feed;
buffering at least one row of the region defined by the at least one marker; and
displaying, on the display device, the region of the frame defined by the at least one marker.

10. The method of claim 9 wherein adding at least one marker includes adding a single marker defining a first corner of the region.

11. The method of claim 9 wherein adding at least one marker includes adding two markers defining opposite corners of the region.

12. A display device for displaying a video feed, the display device comprising:
a display area having horizontal and vertical resolutions;
a parser configured to parse at least one marker from the video feed, the at least one marker defining a region of a frame of the video feed, the region having a horizontal to vertical ratio matching a horizontal resolution to vertical resolution ratio of the display area;
a buffer configured to selectively store rows of the region defined by the at least one marker; and
a video controller configured to display, in the display area, the buffered rows.

13. The display device of claim 12 wherein the at least one marker includes a single marker defining a first corner of the region and further including a processing system configured to calculate from the single marker and the horizontal resolution to vertical resolution ratio a second corner opposite the first corner of the region.

14. The display device of claim 12 wherein the at least one marker includes two markers defining opposite corners of the region.

15. The display device of claim 12 further including an image processor configured to scale the region to fit the horizontal and vertical resolution of the display.

16. A display device for displaying a video feed, the display device comprising:
a display area having horizontal and vertical resolutions;
means for ascertaining at least one marker defining a region of the frame, the region having a horizontal to vertical ratio matching a horizontal resolution to vertical resolution ratio of the display device;
a buffer;
means for storing in the buffer at least one row of the region defined by the at least one marker; and
means for displaying, on the display device, the region of the frame defined by the at least one marker.

17. The display device of claim 16 wherein the means for ascertaining at least one marker includes means for parsing out the at least one marker from the video feed.

18. The display device of claim 17 wherein the means for parsing out the at least one marker from the video feed includes means for parsing out the at least one marker from a header of the video feed.

19. The display device of claim 16 wherein the means for ascertaining at least one marker includes means for fixing the at least one marker for each video feed.

20. The display device of claim 16 wherein the means for ascertaining at least one marker includes means for ascertaining a single marker defining a first corner of the region and means for calculating from the single marker and the horizontal resolution to vertical resolution ratio a second corner opposite the first corner of the region.

21. The display device of claim 16 wherein the means for ascertaining at least one marker includes means for ascertaining two markers defining opposite corners of the region.

22. The display device of claim 16 further including, means for scaling the region to fit the horizontal and vertical resolution of the display.

23. The display device of claim 16 wherein the means for buffering at least one row of the region includes means for buffering each row of the region.

24. A program storage system readable by a computer, tangibly embodying a program, applet, or instructions executable by the computer to perform method steps for fitting a frame of a video feed to a display device, the method comprising:
ascertaining at least one marker defining a region of the frame, the region having a horizontal to vertical ratio matching a horizontal resolution to vertical resolution ratio of the display device;
buffering at least one row of the region defined by the at least one marker; and
displaying, on the display device, the region of the frame defined by the at least one marker.

25. The program storage system of claim 24 wherein ascertaining at least one marker includes parsing out the at least one marker from the video feed.

26. The program storage system of claim 25 wherein parsing out the at least one marker from the video feed includes parsing out the at least one marker from a header of the video feed.

27. The program storage system of claim 24 wherein ascertaining at least one marker includes fixing the at least one marker for each video feed.

28. The program storage system of claim 24 wherein ascertaining at least one marker includes ascertaining a single marker defining a first corner of the region and calculating from the single marker and the horizontal resolution to vertical resolution ratio a second corner opposite the first corner of the region.

29. The program storage system of claim 24 wherein ascertaining at least one marker includes ascertaining two markers defining opposite corners of the region.

30. The program storage system of claim 24 further including, scaling the region to fit the horizontal and vertical resolution of the display.

31. The program storage system of claim 24 wherein buffering at least one row of the region includes buffering each row of the region.
